(19) United States
(12) Patent Application Publication
(10) Pub. No.: US 2026/0217468 A1
(43) Pub. Date: Jul. 30, 2026

(54) WORKPIECE CARRIER SYSTEM

(71) Applicant: EPA GBR, Pappenheim (DE)

(72) Inventor: Georg LEIRITZ, Pappenheim (DE)

(21) Appl. No.: 19/452,249

(22) Filed: Jan. 17, 2026

Related U.S. Application Data
(63) Continuation of application No. PCT/EP2024/068870, filed on Jul. 4, 2024.

(30) Foreign Application Priority Data
Jul. 24, 2023 (DE) 10 2023 119 475.5

(51) Int. Cl. B65G 17/12; B65G 17/24; B65G 17/32; B65G 17/42

(52) U.S. Cl. CPC B65G 17/12; B65G 17/24; B65G 17/326; B65G 17/42

(57) ABSTRACT

A work piece carrier system, including a fixed base element; a drivable traction element revolving at the base element; a work piece carrier; and at least one guide rail, arranged at the base element, and configured to guide rollers of the work piece carrier, wherein the work piece carrier includes a coupling device, configured to couple the work piece carrier with the traction device by friction locking, wherein the work piece carrier includes a plurality of the rollers that are supported at the guide rail so that the work piece carrier is supported by the rollers to roll on the base element, wherein the coupling device is configured to exclusively engage a top side of the traction device oriented away from the base element when coupling with the traction device through friction locking, wherein the guide rail includes a stop for the rollers.

### RELATED APPLICATIONS

This application is a continuation of International patent application PCT/EP2024/068870 filed on Jul. 4, 2024 claiming priority from German patent application DE 10 2023 119 475.5 filed on Jul. 24, 2023, both of which are incorporated in their entirety by this reference.

### FIELD OF THE INVENTION

The invention relates to a work piece carrier.

### BACKGROUND OF THE INVENTION

Work piece carriers are used to transport work pieces to different work stations, e.g., along a transfer line. Thus, a top side of a respective work piece carrier can always remain pointed upward. The work piece carriers either run adjacent to one another, thus the work piece carriers run in a common horizontal plane, or above one another, thus the work piece carriers run in parallel horizontal planes offset from one another, or in particular applications in a combined system, thus the work piece carriers initially run in a common plane and are lifted into another plane by a lifting system. Thus, a drive is required for each plane and for each lifting system.

DE 17 18 135 U describes a work piece carrier system in which the work piece carriers are provided as carts that run on rails and that are connected to a traction device. When the carts reach an end of the transfer line, they are returned to a beginning of the transfer line. The return is achieved by a bridge above the transfer line. The bridge slopes downward from an end of the transfer line to a beginning of the transfer line and is supported by two stands which are arranged at the beginning and at the end of the transfer line. The stands include elevators configured as lifting systems that lift the carts at the end of the transfer line to the return bridge and lower the carts back to the transfer line after having passed through the transfer line. Thus, the work piece carriers run on different levels that require a lifting system. The lifting system, respectively, requires a drive which makes the configuration of the work piece carrier system expensive and complex. Another work piece carrier system described in

DE 29 620 A includes a machine frame that supports a continuous driven traction mechanism, in particular a chain which moves the work piece carriers supported thereon alone by friction. The chain is reversed at two reversal stations, wherein one of the reversal stations is driven.

One problem of known work piece carrier systems is a jam of work piece carriers. In this situation, the work piece carriers shall be decoupled from the traction device. DE 94 21 998 U1 describes a work piece carrier system in which the work piece carriers can be disengaged from the traction device. Thus, fixed support and decoupling devices are required that are configured to disengage passing work piece carriers from the traction device, wherein the work piece carriers are moved by the traction device through friction locking. The engagement and release elements lift the work piece carriers vertically so that the friction locking between the work piece carrier and the traction device is disengaged.

CH 669 167 A5 describes a work piece carrier system running in a single plane, wherein a traction device moves a work piece carrier along using a friction shoe. In order not to load the entire weight of the work piece and of the work piece carrier onto the traction device, an adjustable portion of the weight is transferred to the support track by the rollers. A chain configured as a traction device runs in a U-shaped support. The friction shoe at the work piece carrier is spring-loaded and pressed onto the traction device with a predetermined force while the remaining weight that is not supported on the traction device is transferred onto the support track by the rollers of the work piece carrier. Devices for reducing or removing the friction are required that function self-acting when a work piece carrier hits another work piece carrier in case of a jam.

The documents recited supra do not describe a work piece carrier system with a forward and return path into different levels, which facilitates reliable reversal of the work piece carriers with the traction device at the reversal points and a defined friction locking between traction devices and work piece carriers during normal operations, together with providing reliable operations in case of a jam.

The subject matter of the patent EP 1 999 043 B1 provides an advantage. However, there is a downside in that the friction locked coupling of a respective work piece carrier with the traction device can only be achieved by clamping, which requires engagement of a bottom side as well as of a top side of the traction device. This requires reaching around an edge of the traction device, so that the coupling of work piece carrier and traction device requires an engagement at or in lateral edge areas of the traction device.

The patent DE 10 2017 210 160 A1 shows a similar solution. Thus, a coupling element of a coupling device of the work piece carrier generates self-locking, this means the friction locking between the coupling element and the traction device increases self acting. Thus, it is a disadvantage that the coupling element is not safe for an operator, when the associated disengagement mechanism is damaged since the friction locking between the coupling element and the traction device is not released self acting. The operator can be injured and/or the mechanism can be damaged when the operator or an object, e.g. a stop device, does not stop the work piece carrier and the work piece carrier is not disengaged from the traction device.

### BRIEF SUMMARY OF THE INVENTION

Accordingly, it is an object of the instant invention to provide a work piece carrier system that can be operated safely.

The object is achieved according to the invention by A work piece carrier system, including a fixed base element; a drivable traction element revolving at the base element; a work piece carrier; and at least one guide rail, arranged on the at the base element, and configured to guide rollers of the work piece carrier, wherein the work piece carrier includes a coupling device, configured to couple the work piece carrier with the traction device by friction locking, wherein the work piece carrier includes a plurality of the rollers that are supported in the guide rail so that the work piece carrier is supported by the rollers to roll on the base element, wherein the coupling device is configured to exclusively engage a top side of the traction device oriented away from the base element when coupling with the traction device through friction locking, wherein the guide rail includes a stop for the rollers, wherein the stop is oriented away from the base element so that a lifting of the work piece carrier from the base element during coupling engagement of the coupling device at a top side of the traction device is limited by the stop.

The work piece carrier system includes a stationary base element including a revolving traction device supported and drivable thereon. The base element can include at least two reversal stations where the traction device that is configured continuous can revolve continuously, wherein the traction device is supported in horizontal planes that are arranged parallel to one another. Thus, the traction device is run in an upper run of the workpiece carrier system in a first movement direction, reversed at a terminal reversal station, and run back in an opposite direction in a lower run. The opposite reversal station runs the traction device into the upper run. The work pieces are typically transported in the upper run where the work pieces rest on a support surface of at least one workpiece carrier. Alternatively, the work pieces can be transported in the lower run in a hanging operation. The work pieces are thus suspended at the respective work piece carrier. The traction device may be driven at least at one reversal station by a drive that can be formed by an electric motor. A distance between the reversal stations can be several meters. The traction device can be advantageously configured as a continuously revolving flat belt, having a width that is significantly larger than its thickness. The traction device can be formed, e.g. from polyurethane with reinforcement fibers inserted therein. Other configurations are also conceivable. The traction device includes a top side and a bottom side, wherein the top side according to the invention is the side oriented away from the base element, and the bottom side is the side that is oriented towards the base element.

The work piece carrier system includes at least one work piece carrier that can cooperate with the traction device and that is moveable along a transport path. The work piece carrier is provided and configured to support at least one work piece and a work piece may be transported by plural cooperating work piece carriers. The at least one work piece carrier includes a plurality of rollers, configured to support the work piece carrier in at least one support rail arranged at the base element, wherein the rollers are configured to roll on a rolling plane of the support rail. This way, the work piece carrier can travel along the support rail.

Advantageously, an independent work piece carrier includes at least two respective rollers on both sides, wherein the base element includes two support rails that are respectively associated with one side of the work piece carrier. This way, the work piece carrier can be supported at the base element like a car on four rollers which are arranged at two axles, namely a front axle and a rear axle. A work piece carrier can also be configured as a non-independent trailer which includes only one axle and thus only two rollers, one roller per side. The workpiece carrier, according to the invention, can be connected with another work piece carrier. This can be advantageous for transporting work pieces whose dimensions exceed the dimensions of an individual work piece carrier.

The work piece carrier is positioned above the traction device in order to drive the at least one work piece carrier using the traction device. This means that the traction device can run under the work piece carrier. The work piece carrier includes a coupling device, configured to couple the work piece carrier with the traction device by friction locking as required. The coupling with the traction device is performed by friction locking which transfers the drive force imparted upon the traction device, causing the traction device to revolve at the base element and to transfer the drive force to the work piece carrier, so that the work piece carrier is pulled along by the traction device. In order to perform the coupling of the work piece carrier with the traction device, the coupling device can be transferred from a coupled condition into an uncoupled condition and vice versa, wherein the coupling device forms a friction locking engagement with the traction device when provided in the coupled condition, so that a drive force imparted upon the traction device is transferrable from the traction device to the work piece carrier, and the work piece carrier is drivable along a movement axis of the traction device, wherein the coupling device is decoupled from the traction device in the decoupled condition, so that the traction device can move relative to the work piece carrier without accelerating the work piece carrier. Put differently, the traction device moves under the work piece carrier when the traction device is in the decoupled condition, so that the traction device does not interact with the work piece carrier. Accordingly, the work piece carrier is at a standstill.

The coupling device can be provided in various embodiments, wherein the friction locking between the coupling device and the traction device can have different extents depending on the embodiment, so that the force transfer from the traction device to the work piece carrier can also be performed at varied extents. Thus, a stronger friction locking between the coupling device and the traction device facilitates a greater force transfer from the traction device to the work piece carrier before a slippage of the traction device relative to the work piece carrier or the coupling device occurs.

The work piece carrier system is characterized in that the coupling device is configured to exclusively engage a top side of the traction device that is oriented away from the base element in order to provide form locking coupling with the traction device. The form locking coupling is provided by an engagement of a coupling element with the top side of the traction device. Two-sided clamping of the traction device through a combined effect of two coupling elements that engage the traction device at a top side and a bottom side of the traction device is thus not provided.

Additionally, the work piece carrier system is characterized in that the support rail in which at least a portion of the rollers of the at least one work piece carrier is supported provides a stop for the rollers that is oriented away from the base element. This stop limits a lifting of the work piece carrier from the base element in particular, in the upper run of the work piece carrier system during a coupling engagement of the coupling device with the top side of the traction device. This is done bearing in mind that a unilateral cooperation of the coupling device with the traction device, namely due to the described friction locking engagement of the coupling device with the top side of the traction device, causes a lifting force oriented away from the traction device as a reaction of a pressing of a coupling element of the coupling device onto the top side of the traction device. This can lift the work piece carrier against gravity. In order to prevent the lifting, the rollers of the work piece carrier are supported in the support rail that provides an upper stop for the rollers. The at least one support rail can be configured, e.g. as a C-profile, in order to form the stop. Advantageously, the stop is provided in the upper run and in the lower run at the respective support rail.

It is a core idea of the invention to achieve the friction locking between the work piece carrier and the traction device by unilateral clamping. For this purpose, the work piece carrier includes the described coupling device, advantageously including at least one coupling element that is provided and configured to impact the top side of the traction device, this means, in particular, providing friction locking by pressing onto the top side of the traction device. This coupling element facilitates coupling the work piece carrier with the traction device as described supra. The traction device is supported at the base element that can be coated with a friction reducing coating, in order to reduce a wear on a support surface where the traction device is supported. Additionally, or alternatively, the bottom side of the traction device can be coated with a sliding coating. The support rail is fixed at the base element. The support rail can be bolted onto the base element or welded or glued to the base element.

As soon as a downward force acting in the upper run of the workpiece carrier system between the coupling element and the traction device, wherein the downward force presses the coupling element onto the top side of the traction device, is greater than the weight of the workpiece carrier, including the work piece supported thereon, the workpiece carrier is lifted in a vertical upward direction, oriented away from the base element. Therefore, the guide rail includes the described stop for the rollers that only allow a minor lifting of the work piece carrier including the rollers, since the rollers contact a stop after the workpiece carrier is lifted by a particular lift distance, and the rollers rotate relative to the prior direction of rotation on a lower rolling plane of the guide rail in an opposite rotation direction, and thus roll relative to the guide rail. This rolling occurs relative to the stop accordingly. Last, not least, the traction device is not clamped between an upper and a lower coupling element but only loaded with a pressure force from above.

It is a particular advantage of the invention that the coupling of the at least one workpiece carrier with the traction device can be facilitated by a unilateral cooperation between coupling device and traction device. Accordingly, a two-sided clamping that is described in the prior art is not required. This facilitates to arrange the coupling device distal from lateral edge portions of the traction device, wherein the coupling device has to reach about the lateral edge portion to facilitate the two-sided clamping. Instead, it is possible for the coupling device to cooperate with a center portion of the traction device by at least one coupling element extending in a width direction of the traction device. The edge portions of the traction device can be left open and/or used for other purposes, e.g. to cooperate with a support device. This embodiment is described infra in more detail.

Omitting an edge envelopment of the traction device has the advantage that the workpiece carrier can be disengaged from the traction device much more easily, since no opposite pressure elements or similar engage the bottom side of the traction device, and thus do not have to be brought out of engagement when the work piece carrier is removed from the work piece carrier system. Additionally, a respective work piece carrier can be easily moved from a work piece carrier system to another work piece carrier system automatically. This way, individual work piece carriers can travel virtually unlimited transport distances when several work piece carrier systems are connected in series.

The invention facilitates a simplified configuration of the at least one work piece carrier. The at least one work piece carrier can be configured particularly small and cost-effective, since the traction device is only engaged at a top side of the work piece carrier, and not from both sides as it is common, this means, from the top side and the bottom side.

As an additional advantage, the traction device can be configured particularly narrow, since an entire width of the traction device can be engaged by the coupling device as required. Advantageously, the traction device has a width of 20 mm at the most, advantageously 18 mm at the most, further advantageously, 16 mm at the most. Other dimensions, however, are conceivable as well. The traction device can have a width in a range between 30 mm and 50 mm. Typically, merely a portion of the traction device viewed in a width direction of the traction device is required to cooperate with the coupling device. In particular, a coupling element of the coupling device can engage a center portion of the traction device to cause the coupling.

A small width of the traction device has the advantage that plural work piece carrier systems can be operated adjacent to one another, this means, in a common plane. The work piece carrier systems can also be arranged in parallel planes arranged above one another. This improves flexibility of the work piece carrier system for various applications.

In an advantageous embodiment of the work piece carrier system, the bottom side of the traction device and/or a top side of a support surface of the base element that supports a bottom side of the traction device are provided with a friction-reducing coating. When the support surface of the base element is provided with the friction-reducing coating, only minor wear occurs between the traction device and the friction-reducing coating, thus, even when the work piece carrier is moved along by the traction device. The friction-reducing coating can be formed, e.g. by a polyethylene layer or a polyurethane layer or another friction-reducing material, e.g. Teflon or a polyamide fabric. The coupling device is advantageously sized so that a vertical down force acting between the coupling element and the traction device is sized sufficiently so that the resulting maximum friction force between the coupling element and the traction device reaches an amount that facilitates the work piece carrier being moved along by the traction device.

When the coupling device of the at least one work piece carrier includes at least one coupling element, it is particularly advantageous when the at least one coupling element is formed by an eccentrical element. Advantageously, the coupling device includes at least one coupling element which is advantageously formed by an eccentrical element. The eccentrical element is characterized by having a non-constant radius about a rotation axis, wherein the eccentrical element is rotatably supported about the rotation axis. This way, the coupling element can be brought into frictional engagement with the top side of the traction device and disengaged again. Thus, it is only required to rotate the coupling element about its rotation axis in order to perform the engagement or disengagement. Thus, the rotation axis is arranged relative to the top side of the traction device, so that a distance between the rotation axis and the top side is greater than a minimum radius of the coupling element and smaller than a maximum radius of the coupling element. The rotation axis is advantageously oriented horizontally and transversal to the movement direction of the traction device.

This embodiment facilitates transferring the coupling device from its decoupled state to its coupled state by rotating the coupling element about the rotation axis and thus orienting the coupling element relative to the traction device, so that a portion of a radially outer friction surface of the coupling element with a rather large radius is oriented towards the traction device. Since the radius in this portion exceeds a distance between the top side of the traction device and the rotation axis, a radially outward oriented friction surface of the coupling element comes into frictional engagement with the top side of the traction device, wherein a friction locking engagement and thus coupling between the work piece carrier and the traction device can be established as described supra. Rotating the coupling element can increase engagement of the traction device even further. The coupling condition of the coupling device can thus be provided in different levels, this means, the strength of the coupling with the traction device can be varied. Vice versa, transitioning from the coupled condition into the decoupled condition can be performed by a rotation of the coupling element in the opposite direction about the rotation axis. A coupling element configured as an eccentrical element can establish the intended friction locking between the traction device and the workpiece carrier without jolt and can disengage the coupling again. An intensity of the friction locking is thus variably adjustable.

Particularly advantageously, the non-constant radius of the coupling element, configured as an eccentrical element, is configured so that the coupling element rotates towards a radius that decreases relative to the traction device under an impact of a tangential force component that impacts the coupling element when the coupling element engages the friction device. This means that the coupling element would automatically disengage from the traction device again in this embodiment, due to an absence of external forces, since the tangential force component that represents an opposite force to the friction force between the coupling element and the traction device rotates the coupling element away and thus brings the coupling element out of engagement. In order to provide friction locking between the coupling element and the traction device in this embodiment, a force component has to be applied that counteracts the tangential force component. The force component can be provided, e.g. by a spring element that will be described infra. The spring element, which can be preloaded, causes a torque upon the coupling element, which rotates the coupling element towards the traction device, this means rotates the coupling element about its rotation axis, so that a section of the friction surface of the coupling element contacts the traction device, whose radius exceeds a radius between the rotation axis of the coupling element and the traction device.

It is an advantage of the configuration of the coupling element described supra that the engagement of the coupling element and the traction device is not self-locking, but, to the contrary, disengages when resistance is encountered. This is a great advantage for the operational safety of the work piece carrier system, since the traction device can slide relative to the coupling device when the work piece carrier collides with a foreign object or an operator, so that no substantial or increasing forces are transferred between the traction device and the coupling device. Such large forces could cause injury or damage.

Irrespective of the coupling element being configured as an eccentrical element, it can be advantageous when the coupling element is arranged above a rear axle of the work piece carrier. This is advantageous for a force transfer from rollers arranged at the rear axle of the work piece carrier into the base element of the work piece carrier system.

Advantageously, the traction device is coated with an engagement layer at a top side of the traction device, at least in an engagement portion where the at least one coupling element of the coupling device can engage the top side. The engagement layer can be advantageously made from polyurethane. This engagement layer helps to improve a frictional engagement of the coupling element at the traction device.

As described supra, it can be particularly advantageous to arrange the engagement portion in a center of width portion of the traction device. Thus, it is additionally advantageous when the engagement portion extends only over a portion of an entire width of the traction device. This configuration has the advantage that lateral edge portions of the traction device remain clear and available for other applications.

Edge portions of the traction device can cooperate with a guide device. Advantageously, the traction device includes a guide layer at least in one lateral edge portion, advantageously in both lateral edge portions. The guide layer is advantageously formed by polyurethane or another reduced friction material, e.g. Teflon or a polyamide fabric. The guide layer is provided and configured to cooperate with a guide device, which is arranged at least in one lower run of the workpiece carrier system. The guide device is configured to guide the traction device along the lower run with respect to elevation so that a downward sagging of the traction device due to gravity is prevented. The coating of the traction device with the guide layer in edge portions of the traction device reduces friction between the traction device and the support device and reduces wear of the traction device and energy required for driving the traction device. Accordingly, it is advantageous to arrange the guide layer at least on the top side of the traction device.

According to another advantageous embodiment of the work piece carrier system, the coupling device includes at least one spring element, advantageously configured as a tension spring. The spring element is configured and provided to impart a spring force upon at least one coupling element of the coupling device. The at least one coupling element can be advantageously formed by an eccentrical element as described supra. It is a purpose of the spring element to cause friction locking engagement of the work piece carrier at the traction device by imparting the spring force upon the coupling element. Put differently, the spring element can help to press the coupling element with a sufficiently large vertical down force against the top side of the traction device, so that a resultant maximum friction force that can act between the coupling element and the traction device suffices for the traction device to accelerate the work piece carrier and thereafter move the work piece carrier along. Absent other external forces, the coupling device is in its coupled condition due to the effect of the spring element.

The coupling device advantageously includes an adjustment device, configured to adjust a pre-load of the spring element. This way, a clamping force is adjustable that clamps the respective coupling element against the traction device. The force of the spring element can also be adjusted by using another spring element that has, e.g. another thickness of the spring wire and/or another length.

When the coupling element is formed by an eccentrical element, it is particularly advantageous when the spring element engages the coupling element so that the spring force of the spring element causes a rotation of the coupling element about the rotation axis of the coupling element. As described supra, the rotation of the coupling element causes a distance between the friction surface of the coupling element and the top side of the coupling element to be reduced until the friction locking engagement of the coupling element with the traction device is achieved.

The friction force between the coupling element and the traction device caused by the spring force must not be large enough to wedge and injure an operator by work piece carriers or work pieces arranged thereon for safety reasons when operating the work piece carrier system without an enclosing protective housing. When the resistance exceeds a certain level, the traction device shall slide through at the respective work piece carrier, thus a predetermined slippage will occur. Put differently, a maximum friction force that is transferable between the traction device and the coupling device shall not suffice to move the work piece carrier along against the resistance. This way, injuries can be reliably prevented.

When the work piece carrier system includes a plurality of work piece carriers, so-called jam operations can occur. Thus, plural work piece carriers are in a traffic jam along the traction device directly behind one another. Thus, a work piece carrier moved along by the traction device, wherein the coupling device of the work piece carrier is in a coupling condition, impacts a preceding work piece carrier that is at a standstill. The coupling device of the preceding work piece carrier can be, in particular, in a coupling condition, wherein the work piece carrier is at a standstill, in spite of the coupling device engaging the traction device. This can be achieved, e.g. by a stop device which has been impacted by the preceding work piece carrier. A level of coupling of the preceding work piece carrier can be configured comparatively low in this configuration, this means, the coupling device can establish a rather small amount of friction locking with the traction device. This can be performed, in particular, automatically, by a cooperation of a disengagement element with a respective stop device as will be described supra. The coupling device of the preceding work piece carrier can be in its decoupled condition.

When a trailing work piece carrier impacts a preceding work piece carrier, it is advantageous when the coupling condition of the coupling device of the impacting work piece carrier is at least partially released, this means that the friction locking between the coupling device and the traction device is reduced. It is also conceivable that the coupling device is transferred from its coupled condition into its decoupled condition, this means that the friction locking between the coupling device and the traction device is released completely.

It can be particularly advantageous for self-acting influencing of the coupling condition of the coupling device when at least one work piece carrier includes an impact device in a front portion with respect to a movement direction of the traction device, wherein the impact device impacts the preceding work piece carrier when the work piece carrier hits the respective preceding work piece carrier, so that the coupling device is caused to reduce friction locking between the coupling device and the traction device. Advantageously, the coupling condition is only reduced, this means that a coupling element is pressed onto the top side of the traction device with a reduced vertical down force. This analogously reduces a maximum transferable friction force between the coupling element and the traction device.

Advantageously, the impact device cooperates with the coupling device and cooperates at least indirectly with a coupling element of the coupling device. This is advantageous, in particular, when the coupling element is formed by an eccentrical element as described supra. In this configuration, the coupling element causes a rotation of the coupling element about its rotation axis due to an impact of the impact device at a preceding work piece carrier. This is done so that the coupling element is rotated into an area with smaller radius with respect to the traction device, so that the radially outer friction surface of the coupling element is pressed to a lessor extent onto the top side of the traction device or completely loses contact with the traction device.

In an advantageous embodiment of the work piece carrier system, the impact device includes an activation head, wherein the activation head impacts the preceding work piece carrier when the work piece carrier impacts a preceding work piece carrier. Put differently, the impact device can include an activation head in an advantageous embodiment, wherein the activation head impacts a contact surface of the preceding work piece carrier when the respective work piece carrier impacts a preceding work piece carrier. Thus, the activation head is arranged at a distal end of the impact device, so that the activation head makes first contact with the preceding work piece carrier when the respective work piece carrier impacts the preceding work piece carrier. As described supra, a proximal end of the impact device can cooperate directly with the coupling device in order to influence the respective coupling element, wherein the respective coupling element can be configured, in particular, by an eccentrical element configured as described supra.

Another advantageous embodiment of the work piece carrier includes at least one stop device arranged at the work piece carrier. The stop device is configured to stop at least one work piece carrier that contacts the stop device. This can be performed without transitioning the coupling device of the respective work piece carrier into its decoupled condition in that the stop device imparts an opposite force against the friction force transferred between the coupling device and the traction device, wherein the opposite force exceeds the friction force. Put differently, the stop device must be solid enough so that a friction force acting between the work piece carrier and the traction device is not strong enough to displace the stop device. Thereafter, the traction device slides under the work piece carrier through slippage and slides relative to the coupling device.

According to a particularly advantageous embodiment, impact of the at least one work piece carrier at the stop device causes at least a reduction of the friction locking between the coupling device and the traction device. This prevents unnecessary wear of the traction device and of the coupling device.

The impact device described supra can be used to influence the coupling device when the work piece carrier impacts the stop device. It is also conceivable that the at least one work piece carrier includes a disengagement element which can cooperate with the stop device so that the friction locking between the coupling device and the traction device is at least reduced as soon as the disengagement element impacts the stop device. Using a disengagement element of this type has the advantage that the stop device does not have to cooperate with the impact device like with a preceding work piece carrier, but so that the stop device is particularly configured to cooperate with the disengagement element, e.g. the stop device can only be arranged in an edge portion of the base element.

When a stop device is provided, it can be additionally advantageous for the stop device to be transferrable between an active position and a passive position, wherein the stop device in the active position is configured to stop a respective work piece carrier, and wherein the at least one work piece carrier can be moved by the traction device unimpeded when the stop device is in its passive position. A respective stop device can be moved into a driving area of the at least one work piece carrier to move the at least one stop device from its passive position into its active position, so that an impact device or a disengagement element can cooperate with the stop device. The movement can be, e.g. a pivot movement or a linear movement traveling along a rail.

In a particularly advantageous embodiment, work piece carriers of a work piece carrier system that includes a plurality of work piece carriers cooperate during traffic jam operations so that a contact pressure does not increase as a function of work piece carriers that have come in contact with each other. This is based on the idea that a first work piece carrier that is positioned in front of a series of work piece carriers comes to a standstill due to a cooperation with a stop device. The cooperation of the first work piece carrier with the stop device has the effect that the work piece carrier presses against the stop device due to the friction locking engagement with the traction device. The traction device slides under the work piece carrier, however, the traction device still transfers forces to the work piece carrier due to its sliding friction with the coupling device of the first work piece carrier. Advantageously, the first work piece carrier is configured so that the coupling of the coupling device with the traction device is partially disengaged due to the contact of the work piece carrier at the stop device, this means that the friction locking between the coupling element and the traction device is reduced. This is advantageously performed so that the contact pressure changes relative to the compression force imparted by the coupling element upon the top side of the traction device. When the work piece carrier comes to rest at the stop device, the contact pressure and the friction locking of the coupling device with the traction device are in an equilibrium. The maximum transferable friction force between the traction device and the coupling device is thus reduced so that the traction device can slide through at the work piece carrier. The amount of the friction force, however, is so small that neither the drive of the traction device is loaded excessively nor is the traction device itself subjected to undue wear.

As soon as a second work piece carrier impacts the preceding stationary work piece carrier, the second work piece carrier presses against the preceding work piece carrier with a force. This has the effect that the coupling device of the first work piece carrier is completely transitioned into its decoupled condition, this means the coupling element of the coupling device of the first work piece carrier disengages its engagement at the traction device, since the first work piece carrier is pressed against the stop device from behind. The second work piece carrier, however, in analogy to the process occurring at the first work piece carrier, is influenced by impacting the preceding work piece carrier, so that the coupling condition of the coupling device is adjusted so that the friction locking with the traction device is reduced. Thereafter, the sliding of the traction device and the slippage occurs at the second work piece carrier, but not at the preceding first work piece carrier anymore. The contact pressure at the stop device therefore still corresponds only to the friction force generated by the traction device slipping at one of the two work piece carriers.

Each additional impacting work piece carrier causes a decoupling of the coupling device of a respective directly preceding work piece carrier, so that only the friction force of a coupling device of exactly one work piece carrier engaging the traction device is imparted upon the traction device, irrespective of a number of work piece carriers that are queued up at the front end of the row, this means at the stop device. Therefore, it is not required in this embodiment to use plural stop devices as a function of a number of work piece carriers in a jam, wherein added up stopping forces of several individual work piece carriers would have to be reacted into the base element. Instead, only the stopping force of a single work piece carrier has to be reacted irrespective of the number of queued up work piece carriers.

In order to achieve the described effect, it is particularly advantageous when the coupling device of a respective work piece carrier cooperates with a spring element described supra, as well as with an impact device and/or a disengagement element. The spring element presses the coupling element against the top side of the traction device, wherein the coupling element can be formed, in particular, by an eccentrical element as described supra. The impact device or the disengagement element causes a force upon the coupling element when impacting a stop device or when impacting a preceding work piece carrier, so that the coupling element is rotated about its rotation axis, and the friction force imparted by the friction surface of the coupling element upon the top side of the traction device is reduced.

The system of the spring force that causes the coupling with the traction device and the impact pressure that counteracts the spring force automatically causes an equilibrium in which the coupling element still engages the traction device, so that a friction force between the traction device and the coupling device or the work piece carrier is transferred. This friction force causes the contact pressure of the respective work piece carrier, wherein the work piece carrier presses against the stop device or the respective preceding work piece carrier with the contact force. The friction force, however, only has a small amount, so that the drive of the traction device is treated with care and the traction device is protected against excessive wear.

When a subsequent work piece carrier impacts a preceding work piece carrier and the preceding work piece carrier is additionally pressed against the stop device or against another preceding work piece carrier, the spring force of the spring element of the preceding work piece carrier is overcome in its entirety. This has the effect that the coupling element of the preceding work piece carrier is rotated even further about the rotation axis against the spring force of the spring element and eventually comes out of engagement with the traction device completely in a decoupled condition of the coupling device. According to this principle, any additional impacting work piece carrier transfers the coupling device of the directly preceding work piece carrier into its decoupled condition, so that only the coupling device of the last work piece carrier at the very back end of the row remains in the coupled condition out of the entire row of work piece carriers. As a result, only the contact pressure of a single work piece carrier impacts the stop device, thus irrespective of a number of work piece carriers that are queued up upstream of the stop device.

As described supra, the work piece carrier system can include two reversal stations where the revolving traction device is supported. Typically, at least one of the reversal stations is driven, so that the traction device is drivable to revolve.

In an advantageous embodiment of the work piece carrier system, the at least one work piece carrier includes at least one pressure element which is arranged at a level of the work piece carrier above the traction device when the work piece carrier is used as intended. Advantageously, the pressure element is arranged in a longitudinal direction of the work piece carrier between two rollers of the work piece carrier that are arranged behind one another, in particular, centrally, between a rear roller and a front roller or between a rear axle and a front axle of the work piece carrier.

Advantageously, the pressure element is arranged relative to the traction device, so that the pressure element is arranged slightly above the traction device when the work piece carrier is arranged in an upper conveying section and/or a lower conveying section of the work piece carrier system. A distance of a pressure surface of the pressure element oriented towards the traction device and measured vertically relative to the traction element from a top side of the traction element oriented away from the base element can be 3 mm at the most, advantageously 2 mm at the most, further advantageously, 1 mm at the most. Other distances are also conceivable, e.g. 10 mm or 20 mm.

This arrangement of the pressure element has the effect that the pressure element comes into frictional contact with the top side of the traction device during a reversal of the work piece carrier at a respective reversal station. This is caused by the fact that the work piece carrier is run in an arc along the respective reversal station, wherein the arc, which typically has a constant radius, is caused by a camber of the reversal station. This type of support has the effect as a matter of principle that the traction device is supported between the front axle and the rear axle of the work piece carrier into a higher area of the work piece carrier, due to a curvature of the traction device. Due to the small distance of the pressure element from the traction device, this distance is overcome and a friction contact of the pressure element with the top side of the traction device is caused. This adds an additional component in addition to the friction locking between the work piece carrier and the traction device, wherein the additional component is generated due to the contact of the pressure element with the traction device. This has the effect that an unintentional slippage of the traction device relative to the work piece carrier is rendered less likely.

This slippage between the traction device and the work piece carrier can occur, in particular, in an area of a reversal station. This applies, in particular, to a transfer of a respective work piece carrier from the lower run into the upper run, since the weight of the work piece carrier acts against the friction force during reversal of the work piece carrier, wherein the friction force acts between the traction device and the coupling device. Accordingly, it is advantageous when the friction locking between the work piece carrier and the traction device is increased temporarily in order to prevent an unintentional slippage between the traction device and the work piece carrier.

Accordingly, the pressure element yields the advantage that the pressure force imparted by the coupling element upon the traction device can be kept at a sufficient level so that the friction force suffices for the movement of the work piece carrier in the upper run and in the lower run. This friction force would cause the described slippage for the lift movement of the work piece carrier in the area of the deflection stations, in particular from the lower run to the upper run. This is counteracted by the pressure element as described supra. An improved effect is achieved when the traction device includes an elastic surface at least at its top side, wherein the elastic surface acts like a spring and can generate an opposite pressure for a coupling element as well as for a pressure element.

Advantageously, the pressure element is pre-loadable so that a contact force imparted by the pressure element upon the traction device is adjustable. This way, various load situations of the respective work piece carrier can be reacted to in a flexible manner.

According to an advantageous embodiment of the work piece carrier system, the traction device can be formed by a cog belt, wherein a bottom side of the traction device that is oriented towards the base element is provided with a tooth structure on a tooth side. This embodiment has a particular advantage in that the traction device is drivable in a particularly simple manner, in particular, at a reversal station. The tooth structure can thus mesh, in particular, with a complimentary tooth structure of a drive wheel. This configuration of the traction device requires that an engagement of the coupling device is performed exclusively at a top side of the traction device. When the traction device is clamped from both sides in the prior art, the bottom side of the traction device also has to be configured smooth, so that the traction device can be clamped by a respective coupling element.

### BRIEF DESCRIPTION OF THE DRAWINGS

The invention is subsequently described based on an advantageous embodiment with reference to drawing figures, wherein:

FIG. 1 illustrates a schematic view of a work piece carrier system according to the invention;

FIG. 2 illustrates a view of a coupling device of a work piece carrier cooperating with a traction device;

FIG. 3 illustrates a view of a work piece carrier cooperating with a traction device; and

FIG. 4 illustrates a cross-sectional view of a traction device cooperating with a coupling element.

### DETAILED DESCRIPTION

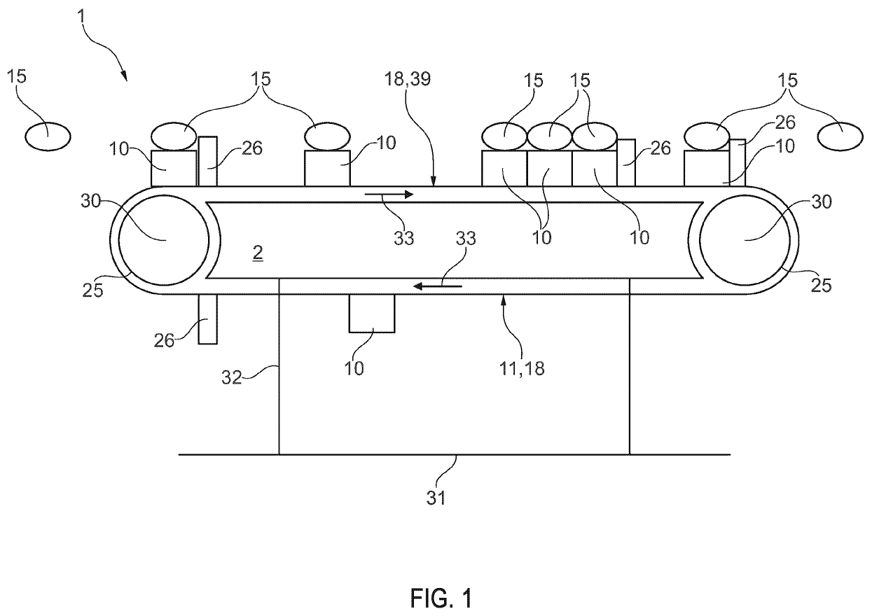

An advantageous embodiment depicted in FIGS. 1-4 includes a work piece carrier system 1 according to the invention, configured to transport work piece carriers 10 along a transport path. The work piece carrier 1 in the illustrated embodiment includes a base element 2, supported by posts 32 on a ground 31. The work piece carrier system 1 additionally includes two reversal stations 25, wherein a traction device 18 is run around the reversal stations under a tension. One of the reversal stations 25 is drivable to rotate, wherein a non-illustrated drive wheel of the reversal station 25 cooperates with a non-illustrated drive, e.g. an electric motor, so that the drive wheel is drivable about a reversal axis 30. This way, the traction device 18 is drivable continuously revolving, moving in a first movement direction 33 in an upper run 39 of the work piece carrier system 1, thereafter reversed at a reversal station 25 and thereafter moves in a parallel plane in a lower run of the work piece carrier system 1 in the opposite movement direction 33. The traction device 18 is supported at the base element 2 between the reversal stations 25, wherein the traction element is supported in the upper run 39 on a support surface that is not illustrated in the drawing figures. In order to reduce friction between a bottom side 5 of the traction device 18 oriented towards the base element 2 and the base element 2, the support surface of the base element 2 and/or a bottom side 5 oriented towards the and/or a bottom side 5 of the traction device 18 oriented towards the base element 2 can be coated with a friction reduced coating.

The traction device 18 is configured as a cog belt in the illustrated embodiment and includes a tooth structure at its bottom side 16. The tooth structure is configured to mesh and cooperate with a complimentary tooth structure of the drive wheel of the respective deflection station that drives the traction device 18. Accordingly, the other deflection station 25 can include a non-driven support wheel, which also includes a complimentary tooth structure, configured to engage the tooth structure 16 of the traction device 18.

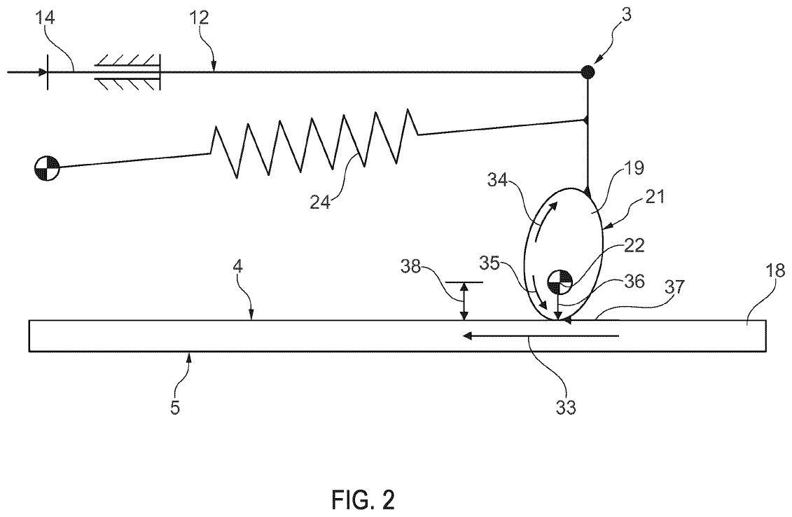

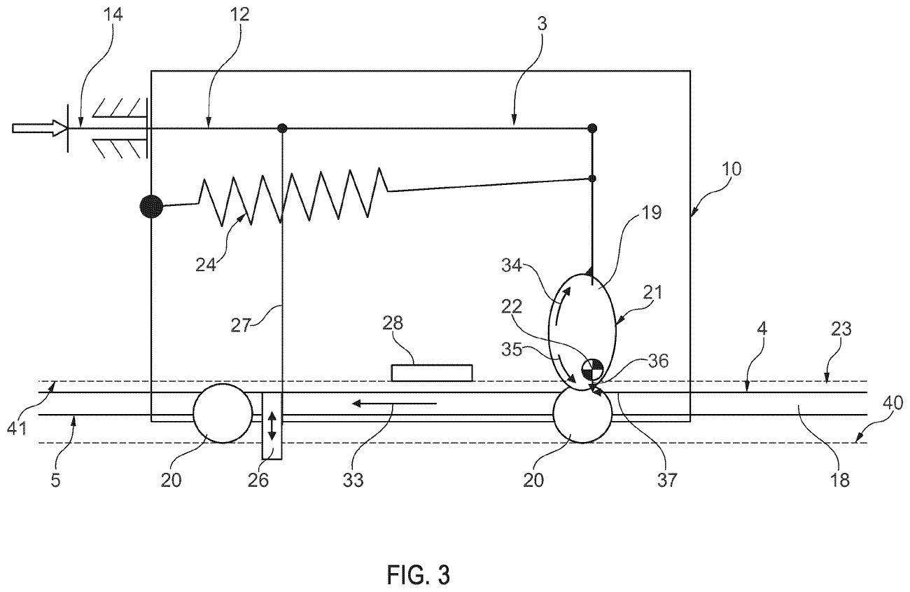

The work piece carrier system 1 additionally includes a plurality of work piece carriers 10 as evident from FIGS. 1 and 3. The work piece carriers 10 are configured to transport work pieces 15 along the transport path of the work piece carrier system 1. According to FIG. 1, work pieces 15 are transported from a left end of the work piece carrier system 1 in the movement direction 33 in the upper run 39 to a right end of the work piece carrier system 1. Thus, the work piece carriers 10 are coupled with the traction device 18 by friction locking. Thus, the work piece carriers 10 respectively include a coupling device whose operating principle is evident from FIG. 2. The coupling device 3 in the illustrated embodiment includes exactly one coupling element 19 that is formed by an eccentrical element. Thus, the coupling element 19 is supported rotatable about a horizontal rotation axis, oriented transversal to a movement direction of the traction device 18, wherein a radially outer friction surface 21 of the coupling element 19 runs on a non-constant radius 38 with reference to the rotation axis 22. Thus, the friction surface 21 can be brought into alternating engagement with a top side 4 of the traction device 18 that is oriented away from the base element 2.

In order to provide the friction locking described supra, the coupling element 19 is rotated about the rotation axis 22, so that the friction surface 21 comes in contact with a top side 4 of the traction device 18. The associated direction of rotation is respectively indicated by an arrow 35 in FIGS. 2 and 3. Since the coupling element 19 contacts the traction element 18, a normal force 36 that acts perpendicular to a top side 4 of the traction device 18 is generated between the coupling element 19 and the traction device 18. This normal force causes a force transfer between the traction device 18 and the coupling element 19 through friction locking. A maximum friction force 37, transferable between the traction device 18 and the coupling element 19, is a function of materials selected for the coupling element 19 and for a respective engagement portion 6 of the traction device 18 or associated friction coefficients.

The coupling element 19 is rotatable in an opposite direction about the rotation axis 22, in order to stop the force transfer between the coupling element 19 and the traction element 18. The associated direction of rotation is indicated by an arrow 34, respectively, in FIGS. 2 and 3. The rotation in this direction of rotation has the effect that the friction surface 21 effectively disengages from the top side of the traction device 18 and thus disengages the friction locking. Therefore, the traction device 18 can pass freely under the respective work piece carrier 10 without causing a connection of the work piece carrier 10 with the traction device 18.

Thus, the coupling element 19 is configured so that its non-constant radius decreases with respect to the traction device 18 when the coupling element 19 rotates in the direction indicated by the arrow 34. An opposite force corresponding to the maximum friction force 37, wherein the opposite force acts upon the coupling element 19 tangential with respect to the rotation axis 22 when the coupling element 19 engages the traction device 18, causes a torque upon the coupling element 19 in this direction of rotation. Accordingly, the coupling device 3 is configured in the illustrated embodiment, so that the friction locking between the traction device 18 and the coupling element 19 is automatically self-locking, e.g. upon an unintentional stop of the work piece carrier 10.

Irrespective of the cooperation of the coupling device 3 with the traction device 18, each work piece carrier 10 is supported at the base element 2 by a total of four rollers 20 in the illustrated embodiment. Thus, the work piece carrier 10 includes a total of two rollers per side, wherein the work piece carrier 10 has a total of two axles, namely, a front axle and a rear axle. In order to support the rollers 20 at the base element 2, the base element 2 includes two support rails 23, oriented parallel to one another at least in the upper run 39 of the work piece carrier 1, in the illustrated embodiment, advantageously, also in the lower run 11, wherein the support rails are respectively configured in a form of a C-profile. Each of the support rails 23 is provided at a side of the respective work piece carrier 10 in order to support the rollers 20. As a matter of principle, the rollers 20 are supportable at least in the upper run 39 of the work piece carrier system 1 on a lower rolling plane 40 of the support rail 23 oriented towards the base element 2. Thus, a weight of the respective work piece carrier 10 including a work piece 15 supported thereon is reacted through the rollers 20 into the support rails 23 and thus into the base element 2.

When the coupling element 19 of the coupling device 3 engages the traction device 18, the normal force 36 recited supra becomes effective. The normal force causes an opposite lifting force in the same amount that impacts the coupling element 19 and thus the respective work piece carrier 10. When the normal force 36 and thus the opposite force is greater than the weight of the work piece carrier 10, the work piece carrier 10 and its rollers 20 lift from the rolling plane 40 of the support rails 23 in an upward direction. The support rails 23 include a stop 41 oriented away from the base element 2 in order to be able to reliably support the work piece carrier 10 at the base element 2, wherein the stop is also configured as a rolling plane. Since the support rails are formed by C-profiles in the illustrated embodiment, the lower rolling plane 40 is formed by a lower flange of the C-profile, and the upper stop 41 is formed by an upper flange of the C-profile.

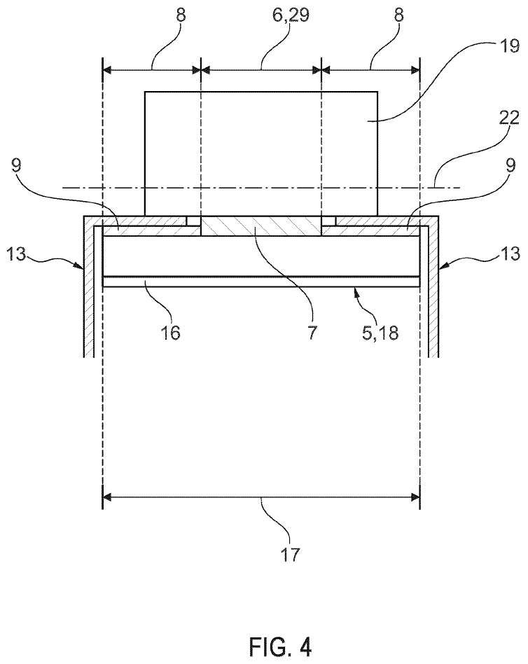

Thus, the work piece carrier system 1 has the ability to couple a respective work piece carrier 10 with the traction device 18 by friction locking in that the traction device 18 engages the coupling device 3 of the respective work piece carrier 10 exclusively at a top side 4 of the traction device 18. Two-sided clamping of the traction device 18 that is used in the prior art is not implemented according to the invention. Accordingly, it is not required that the coupling device 3 cooperates with edge portions 8 of the traction device 18, which differs from the prior art. Instead, it is possible now that the coupling element 19 engages an engagement portion 6 of the traction device 18, wherein the engagement portion 6 is arranged in a center portion 29 of the traction device 18, as evident from FIG. 4.

A width 17 of the traction device 18 is 16 mm in the illustrated embodiment, wherein a width of the engagement portion 6 is 10 mm. The traction device 18 includes an engagement layer 7 in the engagement portion 6, wherein the engagement layer 7 is formed by polyurethane. This engagement layer 7 can have a thickness of, e.g. 2 mm, oriented perpendicular to the top side 4 of the traction device 18. The engagement layer 7 is configured to cooperate with the coupling element 19 directly, wherein a situation where the coupling element 19 engages the traction device 18 is illustrated in FIG. 4. The engagement layer 7 is merely optional.

The traction device 18 includes a respective guide layer 9 in lateral edge portions 8 in the illustrated embodiment, wherein the guide layer 9 is also formed by polyurethane. The guide layer 9 is configured to cooperate with a guide device 13 which includes two L-shaped guide elements in the illustrated embodiment. The guide device 13 can provide elevation guidance for the traction device 18, in particular, in a lower run 11 of the work piece carrier system 1, since the lower run 11 would otherwise sag downward. This sagging is prevented by the guide device 13. The lateral edge portions 8 respectively have a width of 3 mm in the illustrated embodiment, which yields a width 17 of 16 mm for the traction device 18.

It is necessary quite frequently to stop the work piece carriers 10 and the transport of work pieces 15 and to organize operations of the work piece carrier system 1. Thus, a condition of the coupling device 3 is continuously adjustable, in particular, the coupling condition is adjustable, or a decoupled condition is achievable. This is achievable mechanically in the illustrated embodiment, wherein the coupling device 3 includes a spring element 24 and an impact device 12 and a disengagement element 27. These components are shown in particular in FIGS. 2 and 3.

The spring element 24 is formed by a coiled tension spring which causes a rotation of the coupling element 19 in a rotation direction indicated by the arrow 35 through a preloaded pull force. Thus, the pull force stored in the spring element 24 engages an upper end of the coupling element 19 that has a lever arm with reference to the rotation axis 22 and thus causes a torque in a rotation direction indicated by an arrow 35. Thus, the spring element 24 establishes the friction locked connection between the coupling device 3 and the traction device 18, so that the coupling device 3 is in its coupling condition and the respective work piece carrier 10 is pulled along by the traction device 18.

An adjustment of the coupling condition of the coupling device 3 can be desirable, in particular, in two different situations. Thus, the at least one work piece carrier 10 can stop at various locations along the transport path of the work piece carrier system 1. Therefore, the work piece carrier system 1 according to the illustrated embodiment includes a plurality of stop devices 26 as evident from FIG. 1. The stop devices 26 can alternate between a passive position and an active position in that the stop devices 26 are pivoted into an operating range to cooperate with a respective work piece carrier 10 or pivoted out of the operating range, as indicated in FIG. 3 by a double arrow. The work piece carriers 10 respectively include a disengagement element 27 that is configured to engage or impact a stop device 26 when the stop device 26 is in an active position.

The associated principle is evident from FIG. 3. Thus, the work piece carrier 10 whose coupling device 3 is in its coupling condition is moved in the movement direction 33 from a right side to a left side. Eventually, the disengagement element 27 impacts the stop device 26 provided in its active position. The disengagement element 27 is operatively connected directly with the coupling device 3, which imparts a force upon the coupling element 19 against the spring force of the spring element 24 which causes a rotation of the coupling element 19 about the rotation axis 22 in the rotation direction indicated by the arrow 34. This has the effect that the effective radius of the coupling element 19 with respect to the traction device 18 is reduced, this means a contact between the friction surface 13 of the coupling element 19 and the top side 4 of the traction device 18 is reduced. Put differently, the normal force acting between the coupling element 19 and the traction device 18 is reduced. In spite of the force that impacts the coupling device 3 through the disengagement element 27, the spring force continues to impact the spring element 24. As a matter of principle, this spring force cannot be overcome entirely, since this would cause a complete decoupling of the coupling device 3 from the traction device 18, so that the disengagement element 27 would not impart any force upon the coupling device 3 anymore. Instead of completely transitioning the coupling device 3 into its decoupled condition, an equilibrium condition will be established where the coupling element 19 presses onto the top side 4 of the traction device 18, so that a force imparted by the disengagement element 27 upon the stop device 26 is in an equilibrium with the maximum friction force that is transferred between the traction device 18 of the coupling device 3. As a result, the traction device 18 slides under the work piece carrier 10, wherein the described sliding friction force is active, however, it is overcome.

As soon as the stop device 26 is transitioned into its passive position, the spring element 24 pulls back the coupling element 19 as described supra, so that the complete engagement of the coupling element 19 with the traction device 18 caused by the spring element 24 is re-established. Thereafter, the work piece carrier 10 is moved along by the traction device 18 again.

An interruption of the propulsion of the work piece carrier 10 transitioning the coupling device 3 into its decoupled condition is desirable when the work piece carrier 10 impacts a preceding work piece carrier 10. This can occur in particular when the preceding work piece carrier 10 is stopped at a stop device 26 as described supra and thus comes to a standstill. The principle of rotating the coupling element 19 in the rotation direction according to arrow 34 when the work piece carrier 10 impacts a preceding work piece carrier 10 is identical to the preceding description when a stop device 26 cooperates with the disengagement element 27. The work piece carrier 10 includes an impact device 12 at a front end in the movement direction 26, wherein the impact device 12 includes an activation head 14 configured to absorb an impact at the preceding work piece carrier 10. When the work piece carrier 10 impacts the preceding work piece carrier 10, the activation head 14 impacts a corresponding contact surface of the preceding work piece carrier 10. The impact device 12 is operatively connected with the coupling device 3 so that a force is imparted upon the coupling element 19 due to the impact wherein the force rotates the coupling element 19 about the rotation axis 22 into the rotation direction according to arrow 34. As described supra, this reduces the friction locking between the coupling element 19 and the traction device 18, so that the work piece carrier 10 stops while the traction device 18 slides or slips below the work piece carrier 10, transferring a residual friction force.

It is particular to the illustrated embodiment that the impact of a respective work piece carrier 10 at a preceding work piece carrier 10 imparts an impact force upon the preceding work piece carrier 10 which counteracts the spring force of the spring element 24 due to the increased contact force of the disengagement element 27 at the stop device 26. As a consequence, the coupling element 19 is rotated in the rotation direction according to arrow 34 about the rotation axis 22, so that the coupling element 19 loses engagement at the traction device 18. The coupling device 3 of the preceding work piece carrier 10 is in the decoupled condition thereafter. The stop device 26 is therefore still only impacted by the friction force of one work piece carrier 10, namely of the work piece carrier 10 that is at a downstream end of a row of work piece carriers 10 that are queued up in front of the stop device 26. Thus, the dynamic pressure applied to the stop device 26 due to the queued-up work piece carriers 10 reacted into the base element is caused exclusively by the coupling of exactly one of the queued up work piece carriers 10 at the traction device 18, irrespective of the number of work piece carriers 10 that are queued up at a stop device 26.

Advantageously, the work piece carriers 10 in the illustrated embodiment respectively include one pressure element 28 that is arranged above the top side 4 of the traction device 18, this means above a side of the traction device 18 that is oriented away from the base element 2. A distance of the pressure element 28 from the traction device 18 measured perpendicular to the surface 4 is 2 mm in the illustrated embodiment. Consequently, no contact between the pressure element 28 and the traction device 18 is provided during a movement of the work piece carrier 10 in the upper run 39 and/or the lower run 11. This contact, however, is established in an area of the reversal stations 25. At this location, a respective work piece carrier 10 is run on a curved path according to a radius of the respective reversal station about its reversal axis, wherein the traction device is run at a higher level than the work piece carrier 10 as a matter of principle. This is caused by the fact that the work piece carrier 10 is straight between its front axle and its rear axle, whereas the traction device 18 is run at a radius between the front rollers 20 (front axle) and the rear rollers 20 (rear axle) at the respective reversal station 25. This has the effect that the top side of the traction device 18 comes in contact with a top side of the pressure element 28 oriented towards the traction device 18 in the area of the reversal station 25. This generates an additional friction locking between the respective work piece carrier 10 and the traction device 18 in the area of the reversal stations 25. This can counteract, in particular, a reduction of the friction locking between the coupling device 3 and the traction device 18 that can occur due to the re-orientation of the weight force of the work piece carrier 10 relative to the traction device 18 at the reversal stations 25. An unintentional slippage of the traction device 18 with respect to the work piece carrier 10 in the area of the reversal stations 25 can thus be avoided by the pressure element 28. This is relevant, in particular, when switching from the lower run 11 to the upper run 39, since the movement of the respective work piece carrier 10 occurs upward against the weight.

### REFERENCE NUMERALS AND DESIGNATIONS

1 work piece carrier system
2 base element
3 coupling device
4 top side
5 bottom side
6 engagement portion
7 engagement layer
8 edge portion
9 support layer
10 work piece carrier
11 lower run
12 impact device
13 guide device
14 activation head
15 work piece
16 tooth structure
17 width
18 traction device
19 coupling element
20 roller
21 friction surface
22 rotation axis
23 guide rail
24 spring element
25 reversal station
26 stop device
27 disengagement element
28 pressure element
29 center portion
30 reversal axis
31 ground
32 post
33 movement direction
34 arrow
35 arrow
36 normal force
37 friction force
38 radius
39 upper run
40 rolling plane
41 stop

What is claimed is:

1. A work piece carrier system, comprising:
a fixed base element;
a drivable traction element revolving at the base element;
a work piece carrier; and
at least one guide rail, arranged at the base element, and configured to guide rollers of the work piece carrier,
wherein the work piece carrier includes a coupling device, configured to couple the work piece carrier with the traction device by friction locking,
wherein the work piece carrier includes a plurality of the rollers that are supported at the guide rail so that the work piece carrier is supported by the rollers to roll on the base element,
wherein the coupling device is configured to exclusively engage a top side of the traction device oriented away from the base element when coupling with the traction device through friction locking,
wherein the guide rail includes a stop for the rollers, wherein the stop is oriented away from the base element so that a lifting of the work piece carrier from the base element during coupling engagement of the coupling device at a top side of the traction device is limited by the stop.

2. The work piece carrier system according to claim 1, wherein the coupling device includes one coupling element configured as an eccentrical element.

3. The workpiece carrier system according to claim 1,
wherein the coupling device includes a coupling element rotatable about a rotation axis and configured as an eccentrical element which includes a rounded friction surface arranged at a non-constant distance from the rotation axis,
wherein the friction surface is in frictional engagement with the top side of the traction device when the coupling device is in a coupling condition.

4. The work piece carrier system according to claim 2,
wherein an engagement portion of the traction device where the coupling element is able to engage the traction device forming the friction locking coupling is arranged in a center portion of the traction device, and
wherein the center portion is arranged in a center of the traction device viewed in a width direction of the traction device, wherein the engagement portion extends only over a portion of a width of the traction device in the width direction of the traction device.

5. The work piece carrier system according to claim 4,
wherein the traction device includes a guide layer in one lateral portion or in both lateral portions of the traction device, and
wherein the guide layer is made from polyurethane and configured to cooperate with a guide device arranged at the base element in a lower run of the work piece carrier system, so that a gravity induced sagging of the traction device in the lower run is prevented.

6. The work piece carrier system according to claim 1,
wherein the coupling device includes a spring element configured as a tension spring configured to impart a spring force upon a coupling element of the coupling device,
wherein the coupling element is configured as an eccentrical element, and
wherein the spring element is configured to cause the friction locking coupling of the work piece carrier with the traction device through a spring force of the spring element.

7. The work piece carrier system according to claim 6, wherein the coupling device includes an adjustment device configured to adjust a preload of the spring element.

8. The work piece carrier system according to claim 2, wherein the coupling device includes an adjustment device configured to adjust a preload of the spring element, and
wherein the spring element engages the coupling element configured as the eccentrical element, so that the spring force of the spring element causes a rotation of the coupling element in a direction causing a friction locking engagement of the coupling element with the traction device.

9. The work piece carrier system according to claim 1,
wherein the work piece carrier includes an impact device in a front portion viewed in a movement direction of the traction device,
wherein the impact device triggers when the work piece carrier impacts a preceding work piece carrier or an obstacle and reduces the coupling of the coupling device with the traction device or releases the coupling completely.

10. The work piece carrier system according to claim 1, further comprising:
a stop device arranged at the base element,
wherein the work piece carrier includes a displacement element which cooperates with the stop device so that the friction locking caused between the coupling device and the traction device is reduced or released,
wherein the stop device is movable between an active position and a passive position,
wherein the stop device is configured to engage the displacement element of the work piece carrier in the active position of the stop device, and
wherein the stop device is configured not to engage the displacement element of the work piece carrier in the passive position of the stop device.

11. The work piece carrier system according to claim 1,
wherein he coupling device includes a spring element,
wherein the spring element is configured to impart a spring force upon a coupling element configured as an eccentrical element of the coupling device, so that the spring element is enabled to cause the friction locking coupling of the work piece carrier with the traction element,
wherein the work piece carrier includes an impact device in a front portion viewed in the movement direction of the traction device,
wherein the impact device triggers when the work piece carrier impacts a preceding work piece carrier,
wherein the impact device is operatively connected with the coupling device, so that an impact force caused by impacting the impact device is transferred to the coupling device and acts against the spring force of the spring element which reduces or completely releases the friction locking coupling of the work piece carrier at the traction device.

12. The work piece carrier system according to claim 1,
wherein the base element includes at least two reversal stations supporting the traction device to revolve, and
wherein at least one of the reversal stations cooperates with a drive, configured to drive the traction device indirectly or directly.

13. The work piece carrier system according to claim 12,
wherein the work piece carrier includes a pressure element arranged at a level of the work piece carrier above the traction device, in a longitudinal direction of the work piece carrier between the rollers of the work piece carrier,
wherein the pressure element is arranged relative to the traction device so that the pressure element comes in frictional contact with the top side of the traction device during a reversal of the work piece carrier at a reversal station, which generates an additional friction locking between the work piece carrier and the traction device.

14. The work piece carrier system according to claim 13, wherein the pressure element is pre-loadable, so that a contact force of the pressure element at the traction device is adjustable.

15. The work piece carrier system according to claim 1,
wherein the traction device is configured as a cog belt, and
wherein a bottom side of the traction device oriented towards the base element includes a tooth structure.
